(19) United States
(12) Patent Application Publication
(10) Pub. No.: US 2017/0045062 A1
(43) Pub. Date: Feb. 16, 2017

(54) HYDRAULIC FLAT CYLINDER, HYDRAULIC LIFTING CUSHION AND USE THEREOF, AND METHOD FOR ALIGNING A GENERATOR

(71) Applicant: WOBBEN PROPERTIES GMBH, Aurich (DE)

(72) Inventor: Jochen RÖER, Ganderkesee (DE)

(21) Appl. No.: 15/305,644

(22) PCT Filed: Apr. 2, 2015
(86) PCT No.: PCT/EP2015/057330

§ 371 Date: Oct. 20, 2016

(30) Foreign Application Priority Data
May 5, 2014 (DE) 102014208375.3

(51) Int. Cl. F15B 15/10; H02K 15/16

(52) U.S. Cl. CPC F15B 15/10; H02K 15/16

(57) ABSTRACT

A flat hydraulic cylinder comprising a housing which has a first force transmission surface, a second force transmission surface and a housing wall, wherein the second force transmission surface is arranged variably in spacing relative to the first force transmission surface, and a hydraulic connection for the inlet and outlet of hydraulic fluid into and out of the housing.

A hydraulic lift cushion which is in the form of a flat body and is dimensioned for introduction into an air gap between a rotor and a stator. According to the invention disclosure it is proposed that in those items of equipment the housing wall and the first and second force transmission surfaces constitute a one-piece pressure cushion.

### BACKGROUND

Technical Field

The present invention in a first aspect concerns a flat hydraulic cylinder.

Description of the Related Art

Flat hydraulic cylinders generally function satisfactorily in the context of their areas of use, but they have some technical limitations. On the one hand the structural height, in particular in the lifting direction, is relatively great as, to guide the piston in the main body, a certain minimum height must be guaranteed, so that on the one hand a sufficient lift travel is produced and on the other hand no tilting of the body in the main body occurs. A further serious disadvantage with the known flat hydraulic cylinders is the problem that, due to the principle involved, sealing means must be provided between the relatively movable parts of the piston and the main body, the sealing means preventing hydraulic fluid from issuing from the working chamber. In the event of exceeding certain pressures or changes in the fluid composition however due to the principle involved leaks occur. Those limitations mean that flat hydraulic cylinders are not suitable for all purposes of use.

On the German application from which priority is claimed the German Patent and Trade Mark Office searched the following documents: DE 602 08 080 T2, DE 10 2007 036 487 A1, DE 102 03 008 A1 and GB 1 604 141 A.

### BRIEF SUMMARY

Flat hydraulic cylinders are represented in many areas in industry and are used to support or lift loads. For that purpose known flat cylinders have a main body in which a piston is displaceably arranged. A working chamber for a pressure medium is provided between the main body and the piston. Hydraulic fluid is used for heavy loads. The flat cylinder has a first force transmission surface and the piston has a second force transmission surface. When the volume between the piston and the main body is subjected to pressure the piston is moved relative to the main body whereby a lifting movement is produced. When the lifting movement takes place the spacing between the two force transmission surfaces changes.

One or more embodiments are directed to a flat hydraulic cylinder having a housing which has a first force transmission surface, a second force transmission surface and a housing wall, wherein the second force transmission surface is arranged variably in spacing relative to the first force transmission surface, and a hydraulic connection for the inlet and outlet of hydraulic fluid into and out of the housing, wherein the housing wall and the first and second force transmission surfaces form a one-piece pressure cushion.

In that respect one or more embodiments use of the realization that a number of crucial improvements can be achieved at the same time by virtue of the housing wall and the force transmission surfaces being in the form of a one-piece pressure cushion. Because the force transmission surfaces and the housing are connected together in one piece there is no longer any need for sealing means between the various parts. Fluid escape is prevented by virtue of the one-piece structure. In addition the fact that the force transmission surfaces and the housing are in the form of a pressure cushion makes it possible for the two force transmission surfaces to be arranged in immediately adjacent relationship with each other in the pressure-less condition. It is only by the introduction of hydraulic fluid into the housing that the pressure cushion is filled and the force transmission surfaces are spaced further from each other. That structural principle provides a minimal structure height which permits use for example in gaps between two components which are to be lifted off each other or which are to be oriented relative to each other and in which conventional flat hydraulic cylinders cannot be used.

In a preferred development the first and second transmission surfaces are connected together by means of the housing wall, wherein the housing wall is elastically deformable by means of the housing being subjected to pressure. Preferably the housing wall is elastically deformable in such a way that the spacing between the force transmission surfaces in the lift direction changes as a consequence of the elastic deformation.

As can be seen from the foregoing the flat hydraulic cylinder is of a piston-less structure, which results in reduced susceptibility to maintenance.

In a preferred configuration the housing wall of the flat hydraulic cylinder is in the form of a bellows.

In a further preferred configuration the housing has a main body in which the hydraulic connection is provided.

Further preferably the housing wall is formed from a plurality of stacked plates. In a preferred development of this configuration the main body has the first force transmission surface and the housing further has a head member which has the second force transmission surface.

Preferably a first plate is fixed, preferably along its periphery, to the main body, a last plate is fixed to the head member, and stacked between the first and last plates are further plates which on a first side are fixed along a first surface region to an adjacent plate and on a second side in opposite relationship to the first side are connected along a second surface region to a further adjacent plate, wherein provided between the first and second surface regions is a respective displacement transversely relative to the peripheral direction, along which displacement the adjacent plates remain unconnected.

Preferably the plates have a cylindrical outer periphery and in particular are of an annular configuration.

In a preferred configuration the first surface region is in the form of a band which extends inwardly from the outer periphery and the second surface region is in the form of a band which extends outwardly from the inner periphery.

Preferably the plates are respectively connected together by means of laser welding. In that process preferably two plates are laid one upon the other and welded from one side with a constant edge spacing. In that case the two plates fuse and provide a connection which in strength substantially corresponds to the strength of the base material.

In a preferred configuration the hydraulic connection has a coupling for selectively connecting a filling line or a pressure measurement pickup for ascertaining the internal pressure in the housing. Preferably the coupling is in the form of a screw coupling and has a non-return sealing means, for example a ball sealing means. Screw couplings of the above-indicated kind are usually referred to as measurement and test couplings or as test points and can be obtained inter alia under the name “Minimess” from Hydrotechnik GmbH.

As the size of the force transmission surfaces can be easily determined and is thus known it is directly possible at any time to establish, by way of ascertaining the internal pressure in the housing, what pressure force the flat hydraulic cylinder is exerting or carrying. If for example a plurality of flat hydraulic cylinders are operated in a system, such cylinders supporting or lifting the same component at various points, it is possible to ascertain the center of gravity of the component involved, in connection with the geometrical arrangement of the flat hydraulic cylinders with each other and the force respectively exerted or carried by them.

In a second aspect concerns a hydraulic lift cushion. The hydraulic lift cushion also attains the object underlying the flat hydraulic cylinder, namely eliminating the disadvantages due to the principle involved of known flat hydraulic cylinders and in particular providing a lifting device which is leakage-free and involves a minimal component size.

According to one embodiment of the invention the hydraulic lift cushion is in the form of a flat body and is dimensioned for introduction into an air gap, for example into an air gap between a rotor and a stator, and has a first force transmission surface, a second force transmission surface and a housing wall, wherein the second force transmission surface is arranged variably in spacing relative to the first force transmission surface, and a hydraulic connection for the inlet and outlet of hydraulic fluid into and out of the housing, wherein the housing wall and the first and second force transmission surfaces form a one-piece pressure cushion.

The hydraulic lift cushion therefore shares the essential features of the flat hydraulic cylinder according to the first aspect of the invention, with the exception that it is not in the form of a lifting cylinder but in the form of a flat body which is even better suited to being itself introduced into the narrowest of gaps, than the flat hydraulic cylinder. Air gaps like the above-mentioned one are provided for example between a rotor and a stator of a generator of a wind power installation or a hydroelectric power plant. The air gaps between rotor and stator are frequently in the single-digit millimeter range, in the case of generators of wind power installations of the present applicant for example in a range of below 3 mm. For reliable functioning of such generators which in particular can be in the form of slowly rotating synchronous generators it is a matter of substantial significance that the air gap is as constant as possible along its periphery. That requires highly precise orientation between rotor and stator.

As conventional flat hydraulic cylinders cannot be employed for the orientation of such components relative to each other by virtue of their component size and in particular their height in the lift direction, hitherto orientation of the rotor relative to the stator has been effected for example by means of radially oriented adjusting screws or a specifically targeted actuating system, for example the generation of magnetic fields in given peripheral regions of the generator. It was therefore desirable to provide a simpler and at the same time more precise orientation capability, in comparison with the known measures. It is this that the hydraulic lift cushion according to the invention provides.

In a preferred configuration the one-piece pressure cushion has a first volume portion, a second volume portion and a distributor passage connecting the two volume portions in fluid-conducting relationship, wherein the hydraulic connection is arranged at the distributor passage. The hydraulic cushion of such a configuration is similar in its plan view to a lung with two lung lobes. Preferably the first volume portion is dimensioned and adapted to be introduced between a first pole of the rotor and the stator while the second volume portion is dimensioned and adapted to be introduced between a second pole and the stator. The hydraulic connection disposed between the two volume portions can then be arranged between the poles, where structurally there is more space available for the hydraulic connection.

In a further preferred embodiment the first and second force transmission surfaces also of the hydraulic lift cushion are connected together by means of the housing wall, wherein the housing wall is elastically deformable by means of pressurization of the housing in such a way that the spacing between the force transmission surfaces changes.

In the hydraulic lift cushion also, the hydraulic connection preferably has a coupling for selectively connecting a filling line or a pressure measuring pickup for ascertaining the internal pressure in the housing, which in particular is of the configuration in accordance with the above-described embodiment in relation to the flat hydraulic cylinder.

In a further aspect the invention concerns a hydraulic lift system having a fluid feed unit for providing pressurized hydraulic fluid, one or more flat hydraulic cylinders or one or more hydraulic lift cushions, and a fluid line network which respectively provides a fluid-conducting connection between the flat hydraulic cylinders or hydraulic lift cushions and the fluid feed unit.

In the case of a system as set forth hereinbefore the invention also achieves its object in that at least one of the flat hydraulic cylinders, preferably a plurality of or all of the flat hydraulic cylinders, or at least one of the hydraulic lift cushions, preferably a plurality of or all of the hydraulic lift cushions, are designed in accordance with one of the above-described preferred embodiments. A lift system of the above-indicated kind makes it possible in particular for very heavy loads to be carried or lifted by parallel connection of a plurality of flat hydraulic cylinders or hydraulic lift cushions. It is also possible for relatively long stroke travels to be implemented by series connection of a plurality of flat hydraulic cylinders or hydraulic lift cushions, in particular by means of mutual stacking of those flat hydraulic cylinders or hydraulic lift cushions, without in that case leaks occurring at the flat hydraulic cylinders or hydraulic lift cushions. That makes up for the short stroke, resulting from the principle involved, of an individual flat hydraulic cylinder or hydraulic lift cushion.

Preferably in the lift system each flat hydraulic cylinder or each hydraulic lift cushion can be individually subjected to pressure. Thus for example when using a plurality of hydraulic lift cushions for orienting a rotor relative to a stator of a generator, it is possible, by individual pressurization of the hydraulic lift cushions arranged at various locations along the periphery of the air gap, to achieve specifically targeted orientation in a plurality of directions, by each individual internal pressure in the respective housing being appropriately regulated.

In a further aspect the invention concerns a method of orientating the relative position of a rotor with respect to a stator of a generator, in particular a (slowly rotating) synchronous generator, wherein there is an air gap between the rotor and the stator. The method according as explained hereinbefore provides an improved possible way of orienting the rotor and the stator relative to each other in a simple and precise fashion.

The method includes introducing one or more hydraulic lift cushions into the air gap, and actuating the hydraulic lift cushion or cushions with pressurized hydraulic fluid in such a way that the air gap is constant along its periphery. The air gap is preferably monitored along a plurality of locations on its periphery using optical or mechanical measuring means. By way of example manual monitoring is alternatively also possible. Preferably the pressure of a plurality of lift cushions is adapted by means of an electronic control unit or manually incrementally and individually for each hydraulic lift cushion by increasing it or reducing it until the air gap is constant along its entire periphery. According to the invention the reference to a slowly rotating synchronous generator is used to denote a generator in which rotor and stator rotate at a peripheral speed of 40 revolutions per minute or less. Preferred rotary speeds of slowly rotating synchronous generators in wind power installations of the present applicant are typically below 36 revolutions per minute, for example in a range of between 4 revolutions per minute and 34.5 revolutions per minute, in which respect generally the rotary speed decreases with increasing size of the installation (and thus increasing generator diameter).

Slowly rotating synchronous generators are usually to be found in gearless wind power installations.

Further areas of use by way of example of slowly rotating synchronous generators however are also hydroelectric power stations.

Finally the invention also concerns the use of a hydraulic lift cushion in accordance with one of the above-described preferred embodiments for orientation of a generator of a wind power installation. In regard to the advantages according to the invention of such a use attention is directed in their full detail to the foregoing configurations.

### BRIEF DESCRIPTION OF THE SEVERAL VIEWS OF THE DRAWINGS

The invention is described in greater detail hereinafter by means of preferred embodiments and with reference to the accompanying Figures in which:

FIG. 1 shows a diagrammatic sectional view of a flat hydraulic cylinder according to an aspect of the invention,

FIGS. 2 and 3 show perspective views of a hydraulic lift cushion according to an aspect of the invention,

FIGS. 4 and 5 show different detail views of the hydraulic lift cushion of FIGS. 2 and 3, and

FIGS. 6 and 7 show different views of portions of a hydraulic lift cushion as shown in FIGS. 2 to 5 in the orientation of a rotor relative to a stator.

### DETAILED DESCRIPTION

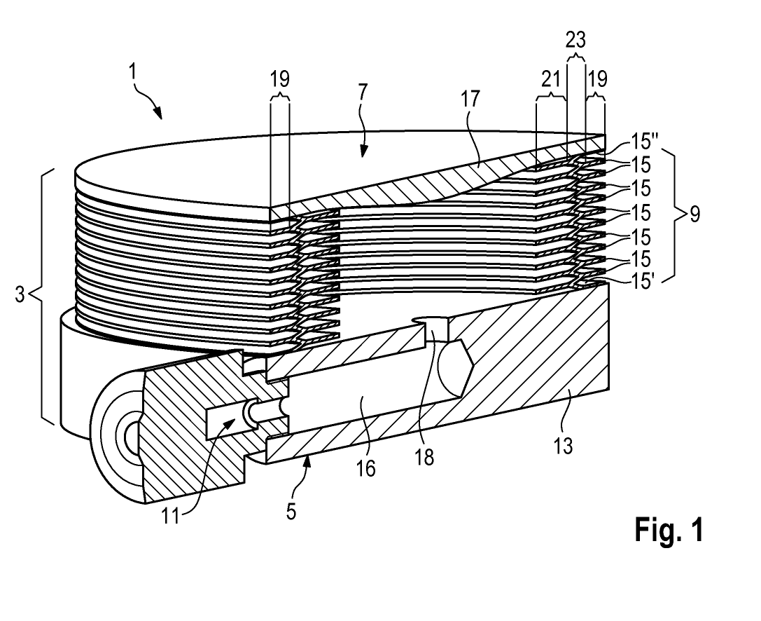

FIG. 1 shows a diagrammatic perspective view in section of a flat hydraulic cylinder 1. The flat hydraulic cylinder 1 has a housing 3. At its underside the housing 3 has a first force transmission surface 5 while at its opposite top side it has a second force transmission surface 7. The force transmission surface 5 and the force transmission surface 7 are connected by means of a housing wall 9 and are arranged variably in their spacing relative to each other.

A hydraulic connection 11 is provided for the inlet and outlet of hydraulic fluid into and out of the interior of the housing 3. The main body 13 has a blind hole 16 and a through bore 18 which provide access to the interior of the housing 3 for the hydraulic fluid.

In the flat hydraulic cylinder 1 in FIG. 1 the housing wall 9 is of a bellows-like configuration. It has a plurality of annular plates 15 stacked one upon the other. Of those plates a first plate 15′ is fixed to the main body 13, a last plate 15″ is fixed to a head member 17 and a plurality of plates 15 which are similar to each other are disposed between the first and last plates 15′, 15″. The plates 15, 15′, 15″ are welded together and to the main body 13 or head member 17 alternately in a first surface region 19 and a second surface region 21. The two surface regions 19, 21 are displaced relative to each other. In the region of the displacement 23 between the welded surface regions 19, 21 the plates 15, 15′, 15″ are elastically deformable, more specifically in such a way that an elastic deformation leads to a variation in spacing of the first force transmission surface 5 relative to the second force transmission surface 7. The larger the displacement region 23 is in the radial direction, the correspondingly greater is the maximum lift travel to be achieved, in conjunction with the number of mutually stacked plates 15.

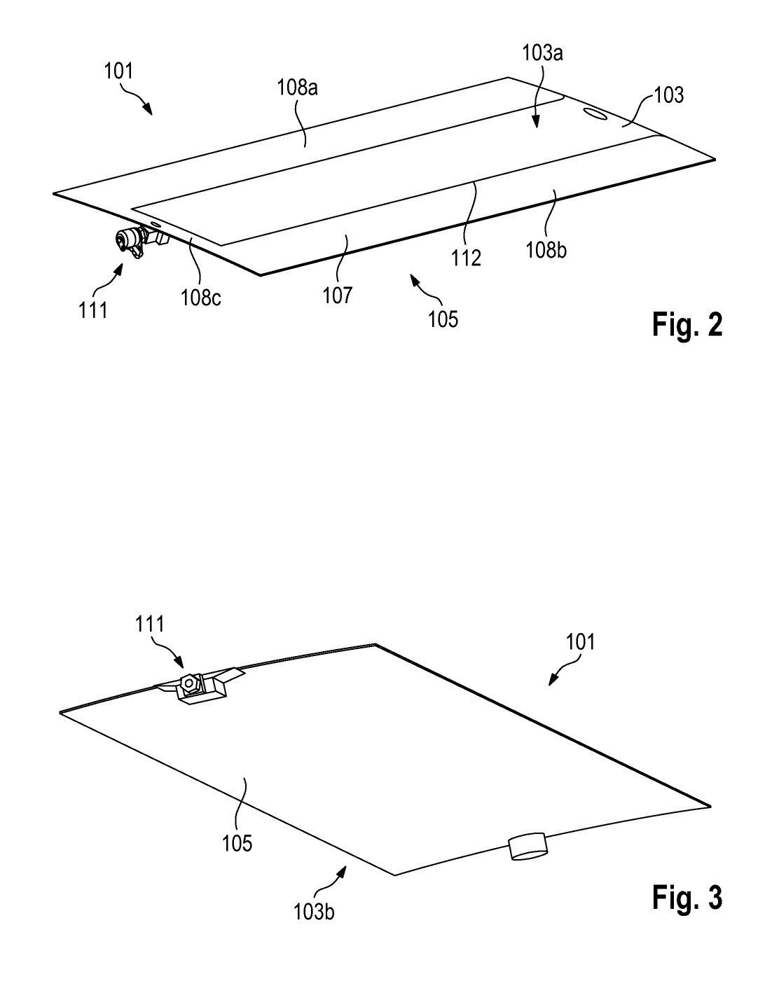

The same seal-less functional principle as in the flat hydraulic cylinder 1 shown in FIG. 1 is also implemented in a hydraulic lift cushion 101 as shown in FIGS. 2 and 3. The hydraulic lift cushion 101 has a housing 103. The housing 103 is formed from two plates which respectively represent a housing wall 103a, 103b. The two plates are not fixedly connected together along their entire surface, but only portion-wise, so that an internal space which is variable in volume is provided between the housing walls 103a, 103b. That internal space provides for the formation of the one-piece pressure cushion and has a first volume portion 108a, a second volume portion 108b and a distributor passage 108c connecting the two volume portions 108a, b. Arranged at the distributor passage 108c is a hydraulic connection 111 which is adapted for the inlet and outlet of hydraulic fluid into and out of the volume portions 108a, b, c of the one-piece pressure cushion.

The two plates 103a, b are welded together along the line 112 in such a way that the plates 103a, b remain unconnected in the regions in which the volume portions 108a, b, c are disposed.

Like also the flat hydraulic cylinder 1 in FIG. 1 the hydraulic lift cushion 101 in the form of the flat member has a first force transmission surface 105 which is the lower surface in FIGS. 2 and 3, and an oppositely disposed second force transmission surface 107. The spacing of the force transmission surfaces 105, 107 from each other is altered by introducing hydraulic fluid into the volume portions 108a, b, c through the hydraulic connection 111.

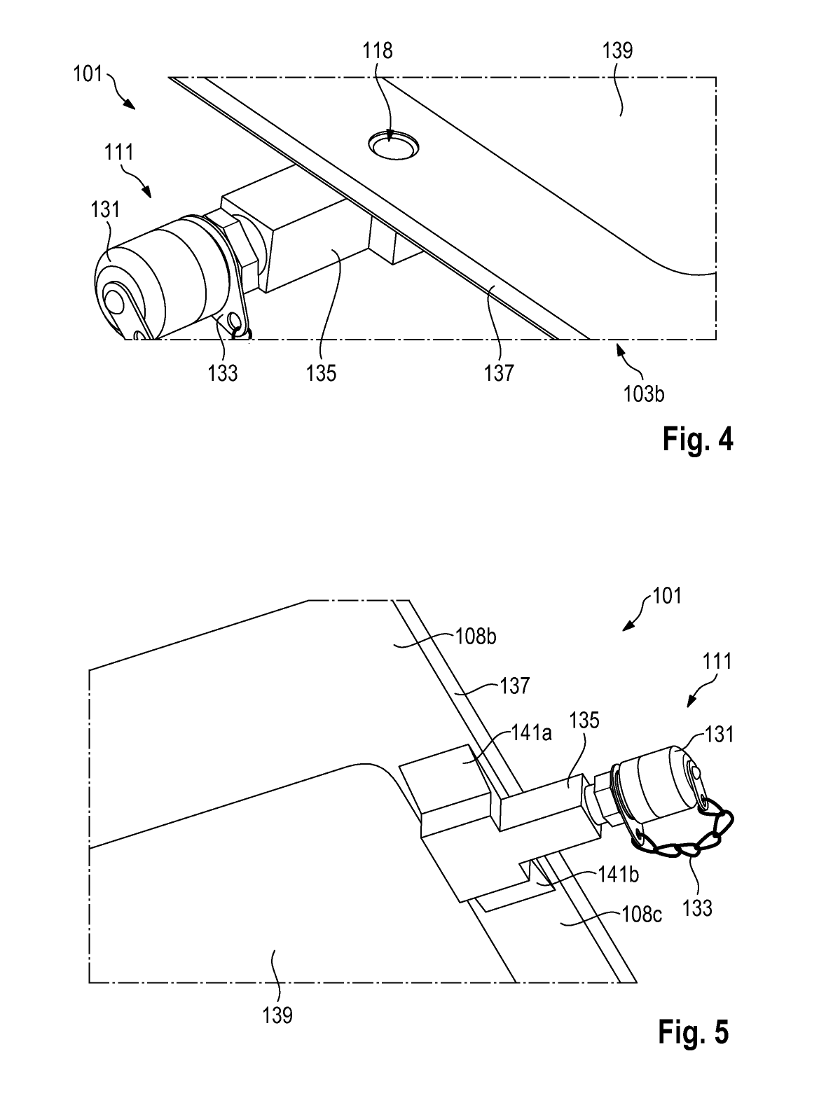

The hydraulic connection 111 is shown in greater detail in FIG. 4. A main body 135 has a through opening 118 into the distributor passage 108c. The hydraulic connection 111 can be closed by means of a pressure-tight cap 131 which is fixed to the main body 135 by means of a loss-prevention retainer 133. The surface regions 137 and 139 shown displaced in FIG. 4 represent the regions in which the illustrated plate 103b is connected to the oppositely disposed plate 103a (FIGS. 2 and 3).

As can also be seen from FIG. 5 the main body 135 has two positioning wedges 141a, b which extend laterally away from the main body and which serve to position the hydraulic lift cushion 101 in an air gap between a rotor and a stator of a generator. That will be described in greater detail with reference to the following Figures.

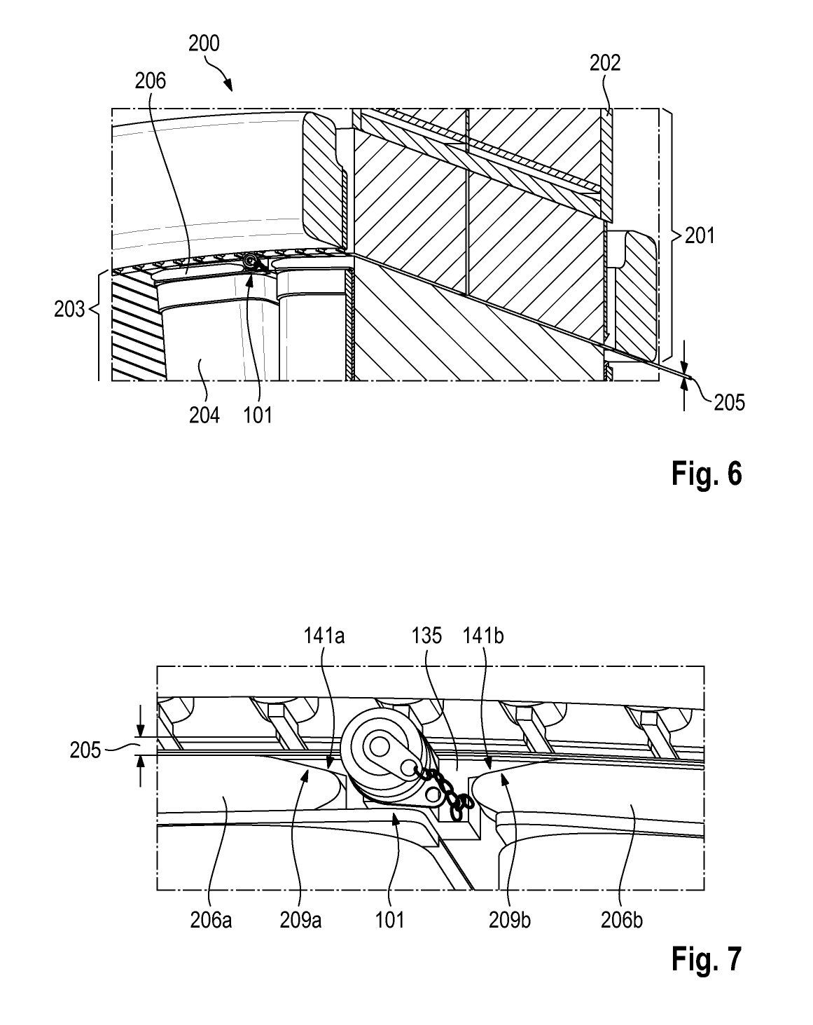

FIGS. 6 and 7 show a portion of a generator 200. The generator 200 can be for example a slowly rotating synchronous generator of a wind power installation or a hydroelectric power station. The generator 200 has a stator 201 which substantially includes a stator carrier 202 and a plurality of windings in the form of stator plate packs. The generator further comprises a rotor 203 which includes a plurality of pole shoes 204 and pole heads 206 on the pole shoes.

There is an air gap 205 between the stator 201 and the rotor 203. Introduced into the air gap 205 in FIGS. 6 and 7 is a hydraulic lift cushion 101 which is of a configuration as shown in the foregoing Figures.

As can be seen in particular from FIG. 7 the lift cushion 101 is introduced into the air gap 205 in such a way that the positioning wedges 141a, b bear against inclined surfaces 209a, b of a corresponding configuration on adjacent pole heads 206a, b. In that way the hydraulic lift cushion is positioned centrally in relation to the adjacent pole heads 206a, b. The main body 135 of the hydraulic lift cushion 101 takes its place in the space between the adjacent pole heads 206a, b.

The method is preferably carried out in such a way that there is provided a stator 201, in the interior of which is arranged a rotor 203, with an air gap between the stator 201 and the rotor 203. To orient the rotor 203 and the stator 201 relative to each other in such a way that the air gap is of a size as equal as possible along its periphery one or more hydraulic lift cushions 101 are disposed in the air gap between the stator 201 and the rotor 203, preferably in the arrangement shown in FIGS. 6 and 7, so that a first volume portion of the hydraulic lift cushion extends over a first pole head 206a and a second volume portion extends over a second adjacent pole head 206b. Preferably the one or more hydraulic lift cushions are introduced into the air gap at the narrowest location thereof. After the hydraulic lift cushion or cushions have been introduced they are subjected to pressure in such a way that the gap is enlarged. After the desired gap size is reached the rotor is fixed relative to the stator in relation to the position of its axis of rotation and the hydraulic lift cushion or cushions is or are removed again, preferably after pressure relief.

Subsequently to fixing of the rotor relative to the stator, which is effected in a generally known fashion in the assembly of a wind power installation or a generator of another kind, the hydraulic lift cushions can be relieved of load and removed.

The use of the hydraulic lift cushion for orienting the relative position between rotor and stator of a generator will also be apparent from the foregoing.

As can also be seen from the foregoing the invention provides a particularly simple and possible way of orienting rotors and stators of generators relative to each other in such a way that a constant air gap between the components is achieved. The hydraulic lift cushions can be produced in economical fashion and are re-usable, which involves significant advantages specifically when manufacturing large numbers of items.

1. A flat hydraulic cylinder comprising:
a housing having a first force transmission surface, a second force transmission surface and a housing wall, wherein the second force transmission surface is arranged variably in spacing relative to the first force transmission surface, and
a hydraulic connection providing an inlet and an outlet for hydraulic fluid to flow into and out of the housing,
wherein the housing wall and the first and second force transmission surfaces form a one-piece pressure cushion.

2. The flat hydraulic cylinder according to claim 1 wherein the first and second transmission surfaces are connected together by the housing wall, wherein the housing wall is elastically deformable by the housing being subjected to pressure.

3. The flat hydraulic cylinder according to claim 1 wherein the flat hydraulic cylinder is a piston-less structure.

4. The flat hydraulic cylinder according to claim 1 wherein the housing wall is in a configuration of a bellows.

5. The flat hydraulic cylinder according to claim 1 wherein the housing has a main body, the hydraulic connection being in the main body.

6. The flat hydraulic cylinder according to claim 1 wherein the housing wall is formed from a plurality of stacked plates.

7. The flat hydraulic cylinder according to claim 6 wherein the main body has the first force transmission surface and wherein the housing has a head member having the second force transmission surface.

8. The flat hydraulic cylinder according to claim 7 wherein the housing has a main body, wherein a first plate of the plurality of stacked plates is fixed to the main body, a last plate of the plurality of stacked plates is fixed to the head member, and stacked between the first and last plates are remaining plates of the plurality of stacked plates, the remaining plates being fixed on a first side along a first surface region to an adjacent plate and on a second side in opposite relationship to the first side are connected along a second surface region to an adjacent plate, wherein provided between the first and second surface regions is a displacement transversely relative to the peripheral direction, along which displacement the adjacent plates remain unconnected.

9. The flat hydraulic cylinder according to claim 6 wherein the plurality of stacked plates have a cylindrical outer periphery, and in particular and are of an annular configuration.

10. The flat hydraulic cylinder according to claim 8 wherein the first surface region is a band that extends inwardly from an outer periphery and the second surface region a band which extending outwardly from an inner periphery.

11. The flat hydraulic cylinder according to claim 6 wherein the plurality of plates are respectively connected together by laser welding joints.

12. The flat hydraulic cylinder according to claim 1 wherein the hydraulic connection has a coupling for selectively connecting a filling line or a pressure measurement pickup for ascertaining the internal pressure in the housing.

13. A hydraulic lift cushion in the form of a flat body and is dimensioned for introduction into an air gap between a rotor and a stator, the hydraulic lift cushion comprising:
a housing comprising a first force transmission surface, a second force transmission surface and a housing wall, wherein the second force transmission surface is arranged variably in spacing relative to the first force transmission surface, and
a hydraulic connection for the inlet and outlet of hydraulic fluid into and out of the housing,
wherein the housing wall and the first and second force transmission surfaces form a one-piece pressure cushion.

14. The hydraulic lift cushion according to claim 13 wherein the one-piece pressure cushion has a first volume portion a second volume portion and a distributor passage connecting the first and second volume portions in fluid-conducting relationship, and wherein the hydraulic connection is arranged at the distributor passage.

15. The hydraulic lift cushion according to claim 13 wherein the first and second force transmission surfaces are connected together by the housing wall, wherein the housing wall is elastically deformable by the housing being subjected to pressure in such a way that a spacing between the first and second force transmission surfaces changes.

16. The hydraulic lift cushion according to claim 13
wherein the hydraulic connection has a coupling for selectively connecting a filling line or a pressure measurement pickup for ascertaining the internal pressure in the housing.

17. A hydraulic lift system comprising:
a fluid feed unit for providing pressurized hydraulic fluid,
at least one of one or more flat hydraulic cylinders and one or more hydraulic lift cushions; and
a fluid line network that produces a fluid-conducting connection between the flat hydraulic cylinders or hydraulic lift cushions and the fluid feed unit,
wherein at least one of the flat hydraulic cylinders comprises a housing having a first force transmission surface, a second force transmission surface and a housing wall, wherein the second force transmission surface is arranged variably in spacing relative to the first force transmission surface, and
a hydraulic connection providing an inlet and an outlet for hydraulic fluid to flow into and out of the housing,
wherein the housing wall and the first and second force transmission surfaces form a one-piece pressure cushion.

18. The lift system according to claim 17 wherein each flat hydraulic cylinder or each hydraulic lift cushion is configured to be actuated with an individual pressure.

19. A method of orienting the relative position of a rotor with respect to a stator of a synchronous generator, wherein the generator includes an air gap between the rotor and the stator, the method including the steps:
introducing one or more hydraulic lift cushions into the air gap, and
actuating the hydraulic lift cushion or cushions with pressurized hydraulic fluid in such a way that the air gap is constant along its periphery.

20. (canceled)

21. lift system according to claim 17 wherein the one or more hydraulic lift cushions comprises:
a housing comprising a first force transmission surface, a second force transmission surface and a housing wall, wherein the second force transmission surface is arranged variably in spacing relative to the first force transmission surface, and
a hydraulic connection for the inlet and outlet of hydraulic fluid into and out of the housing,
wherein the housing wall and the first and second force transmission surfaces form a one-piece pressure cushion
